(19) United States
(12) Patent Application Publication
(10) Pub. No.: US 2018/0158417 A1
(43) Pub. Date: Jun. 7, 2018

(54) DISPLAY PANEL AND DISPLAY DEVICE

(71) Applicant: WUHAN TIANMA MICRO-ELECTRONICS CO.,LTD., WUHAN (CN)

(72) Inventors: Dongxu XIANG, SHANGHAI (CN); Renyuan ZHU, SHANGHAI (CN); Yue LI, SHANGHAI (CN); Yana GAO, SHANGHAI (CN); Xingyao ZHOU, SHANGHAI (CN); Zhonglan CAI, SHANGHAI (CN)

(73) Assignee: WUHAN TIANMA MICRO-ELECTRONICS CO.,LTD., WUHAN (CN)

(21) Appl. No.: 15/889,164

(22) Filed: Feb. 5, 2018

(30) Foreign Application Priority Data
Sep. 8, 2017 (CN) 201710807089.6

(51) Int. Cl. G09G 3/3258

(52) U.S. Cl. CPC G09G 3/3258; G09G 2300/0819; G09G 2300/0426; G09G 2320/0233

(57) ABSTRACT

Disclosed are a display panel and a display device. When a display area is divided into a first display area and a second display area, and the number of pixels in a row of pixels in the second display area is smaller than the number of pixels in a row of pixels in the first display area, a load on a scan signal line connected with a row of pixels in the second display area is lower than a load on a scan signal line connected with a row of pixels in the first display area, and at least one of the respective scan signal lines connected with the respective rows of pixels in the second display area is connected with a compensation capacitor.

### CROSS REFERENCE TO RELATED APPLICATION

This application claims priority to Chinese Patent Application No. 201710807089.6, filed with the Chinese Patent Office on Sep. 8, 2017. The entire disclosure of the above application is incorporated herein by reference.

### FIELD

The present disclosure relates to the field of display technologies, and particularly to a display panel and a display device.

### BACKGROUND

As the display technologies are advancing, a full-screen with a larger screen-to-body ratio and a narrow bezel can greatly improve a visual effect as compared with a general display screen, and thus has been widely favored. At present, typically a front camera, a headphone, a finger recognition area, a physical button, etc., is arranged on the front of a display device including the full-screen, e.g., a mobile phone, etc., to perform self-photographing, video call, finger recognition, and other functions. As can be seen from FIG. 1 which illustrates a schematic structural diagram of a display panel, in which the front camera 10, the headphone 20, etc., are typically arranged in a topmost non-display area of the display panel, and the finger recognition area or the physical button 30, etc., is typically arranged in a bottommost non-display area. However, with such arrangement, the screen-to-body ratio of the display panel is discouraged from being further improved.

### SUMMARY

Embodiments of the disclosure provide a display panel and a display device so as to address the problem in the related art of non-uniformity of an image displayed in an notch-shaped area.

In one aspect, an embodiment of the disclosure provides a display panel. The display panel includes a display area including a plurality of rows of pixels, and scan signal lines connected with the respective rows of pixels. The display area is divided into a first display area and a second display area, and the number of pixels in a row of pixels in the second display area is smaller than the number of pixels in a row of pixels in the first display area. Further, at least one of the respective scan signal lines connected with the respective rows of pixels in the second display area is connected with a compensation capacitor.

In another aspect, an embodiment of the disclosure further provides a display device including the display panel above according to the embodiment of the disclosure.

### BRIEF DESCRIPTION OF THE DRAWINGS

FIG. 1 is a schematic structural diagram of a full-screen in the related art.

FIG. 2A to FIG. 2D are schematic diagrams illustrating particular wiring in a display panel of the full-screen respectively.

FIG. 3A to FIG. 3C show schematic structural diagrams of a display panel according to an embodiment of the disclosure respectively.

FIG. 4 shows a schematic structural diagram of a scan signal line connected with a compensation capacitor in a display panel according to an embodiment of the disclosure.

FIG. 5A shows a schematic structural diagram of a pixel in a second display area of a display panel according to an embodiment of the disclosure applicable to an OLED display panel.

FIG. 5B shows a schematic structural diagram of a pixel in a first display area of a display panel according to an embodiment of the disclosure applicable to an OLED display panel.

FIG. 6 shows a schematic structural diagram of a pixel corresponding to FIG. 5A and FIG. 5B.

FIG. 7 shows a schematic structural diagram of a pixel in a second display area of a display panel according to an embodiment of the disclosure applicable to an LCD display panel.

FIG. 8A to FIG. 8C show schematic structural diagrams of a display panel having a notch-shaped area according to an embodiment of the disclosure respectively.

FIG. 9 shows a schematic structural diagram of a display panel having a notch-shaped area with the outline of a part of an edge thereof being an arc according to an embodiment of the disclosure.

FIG. 10A and FIG. 10B each shows a schematic diagram of a display panel having a notch-shaped area according to another embodiment of the disclosure respectively.

FIG. 11 shows a schematic structural diagram of a display panel according to another embodiment of the disclosure.

FIG. 12 shows a schematic structural diagram of a display device according to an embodiment of the disclosure.

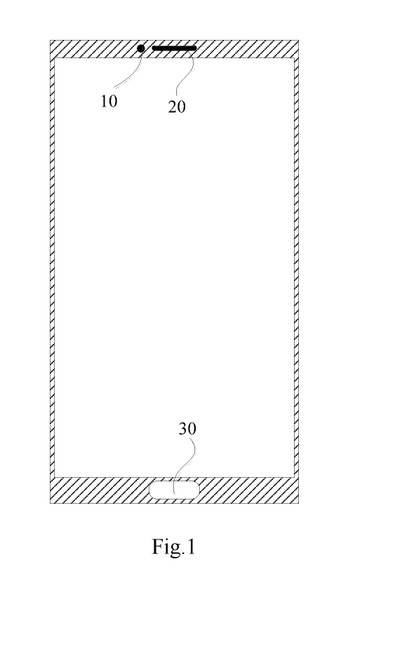

### DETAILED DESCRIPTION OF THE EMBODIMENTS

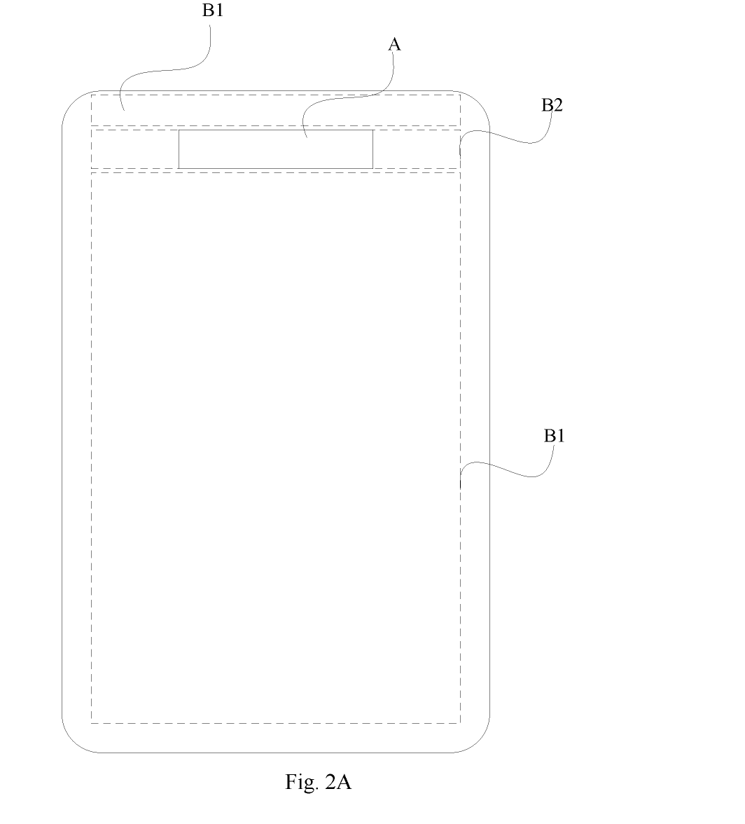

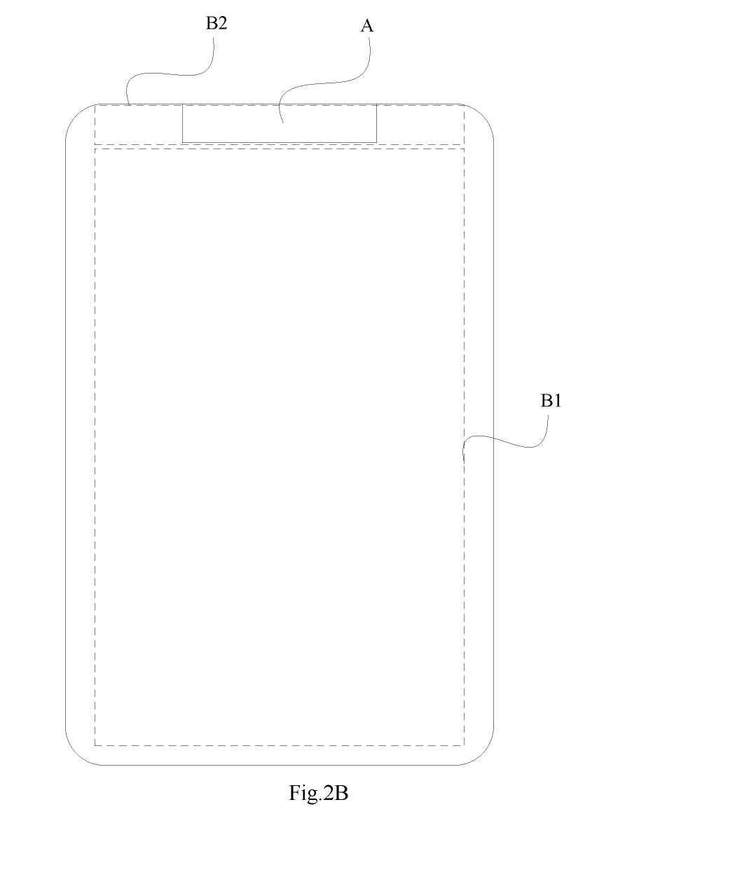

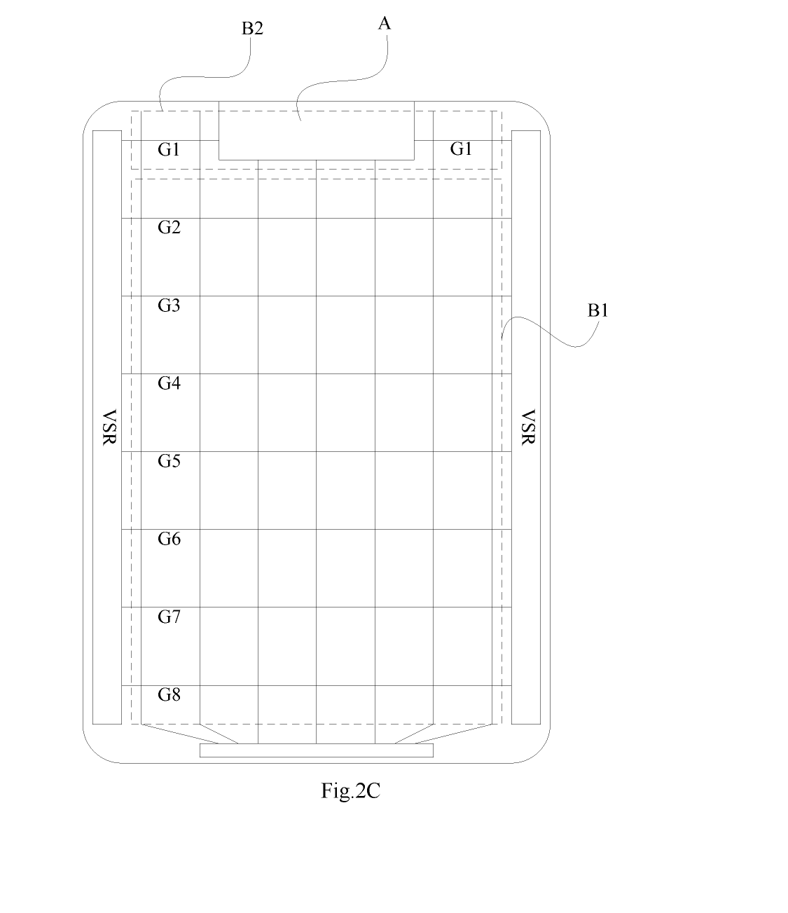

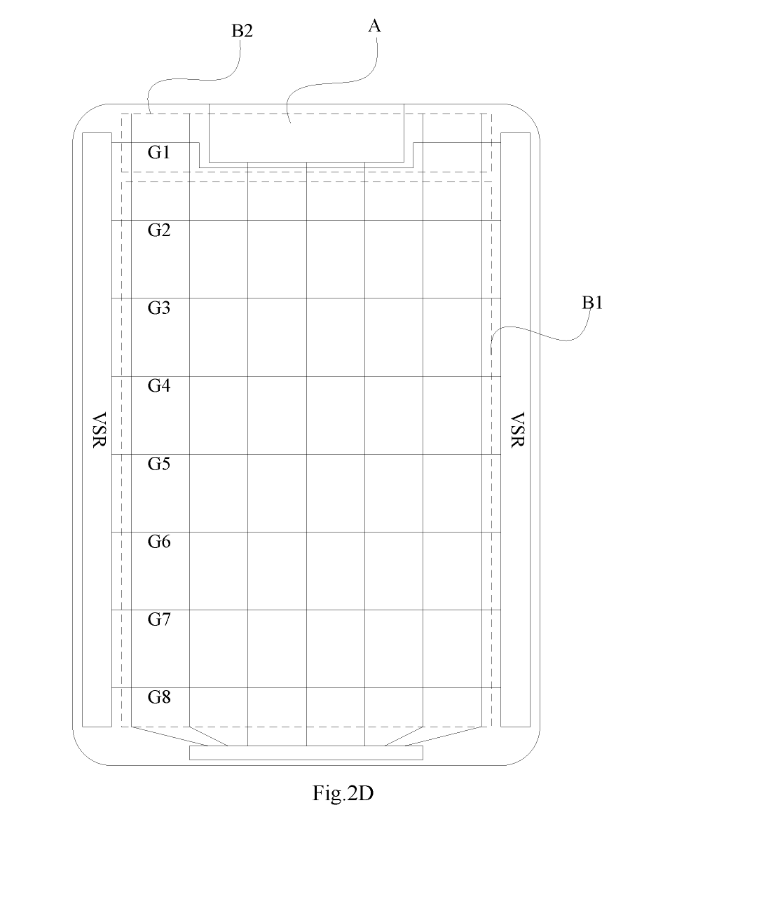

In order to display throughout a screen, as illustrated in FIG. 2A and FIG. 2B, a camera, a headphone, or another device is typically arranged in a notch-shaped area A of a display panel, so that the number of pixels in a row of pixels in a first display area B1 of the display panel is larger than the number of pixels in a row of pixels in a second display area B2. Here the second display area B2 is an area adjacent to the notch-shaped area A on the left and the right thereof. However, with the above design, the load on scan signal lines connected to the respective rows of pixels in the first display area B1 will be different from those in the second display area B2, thus resulting in non-uniformity of a displayed image due to non-uniform writing of data.

In the display panel including the notch-shaped area A, the notch-shaped area A is located at the very top of the display area of the display panel as illustrated in FIG. 2B by way of an example.

As illustrated in FIG. 2C, since a substrate of the display panel in the notch-shaped area A is cut away, a scan signal line G1 arranged in the second display area B on both the sides of the notch-shaped area A is broken in the notch-shaped area A. In order to enable a signal to be applied to the scan signal line G1 on both the sides of the notch-shaped area A, gate driving circuits VSR may need to be arranged on both sides of the display area of the display panel, where the scan signal line G1 in the second display area B2 is driven unilaterally, and scan signal lines G2, G3, G4, G5, G6, G7, and G8 in the first display area B1 are driven bilaterally, which may induce significant differences in load and delay between the scan signal line G1, and the scan signal lines G2, G3, G4, G5, G6, G7, and G8, thus resulting in non-uniform writing of data in the first display area B1 and the second display area B2.

As illustrated in FIG. 2D, scan signal lines G1 arranged in the second display area B on both the sides of the notch-shaped area A are connected with each other by detouring along the edge of the notch-shaped area A so that all the scan signal lines G1, G2, G3, G4, G5, G6, G7, and G8 are driven bilaterally. Although a difference in load between the scan signal lines G1, and the scan signal lines G2, G3, G4, G5, G6, G7, and G8 can be alleviated, the width of the frame of the notch-shaped area A will be increased, so the size of the effective display area will be reduced, and a design of the narrow bezel will be discouraged. Furthermore there still are different loads on the scan signal lines G1, G2, G3, G4, G5, G6, G7, and G8 due to different numbers of pixels connected thereto.

Apparently the problem of non-uniformity of a displayed image will arise in the existing display panel with a notch-shaped area.

In view of the problem in the related art of non-uniformity of a displayed image due to a notch-shaped area, embodiments of the disclosure provide a display panel and a display device. The display panel and the display device according to the embodiments of the disclosure will be described below in details with reference to the drawings. It shall be appreciated that some embodiments to be described below are merely intended to illustrate and describe the disclosure, but not to limit the disclosure thereto. The embodiments of the disclosure, and the features in the embodiments can be combined with each other unless they conflict with each other.

The shapes and sizes of respective components in the drawings are not intended to reflect any real proportion, but merely intended to illustrate the disclosure of the disclosure.

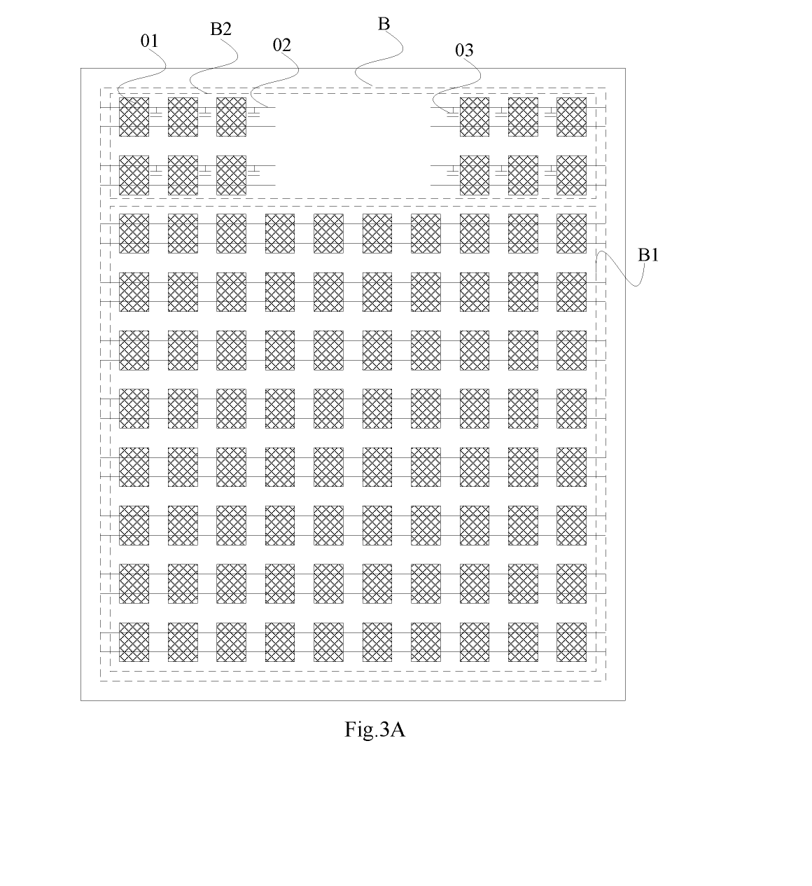

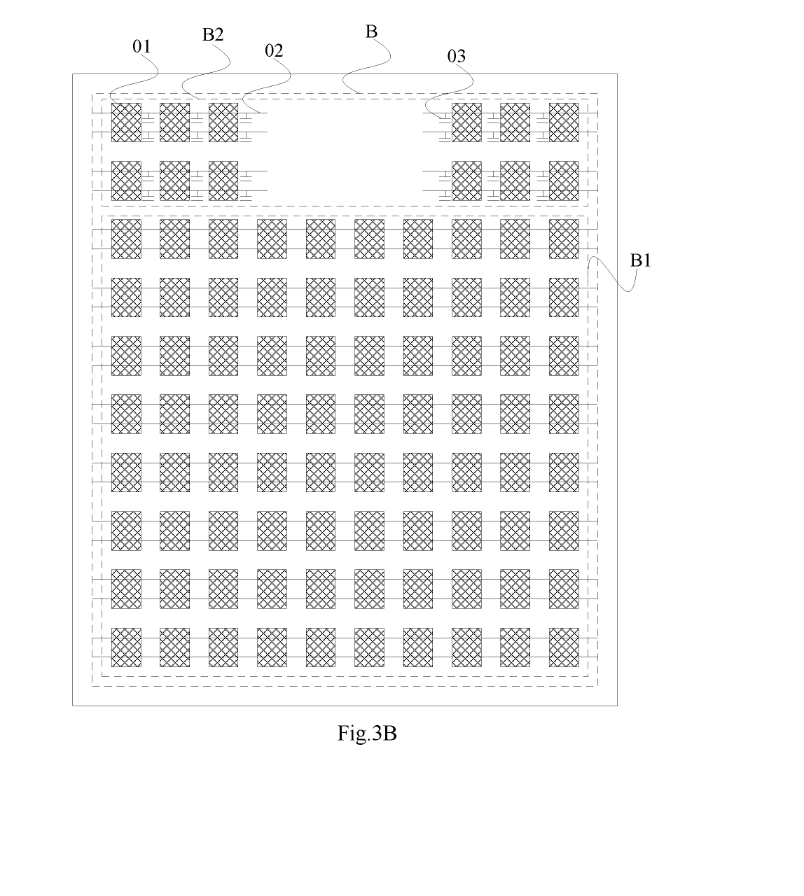

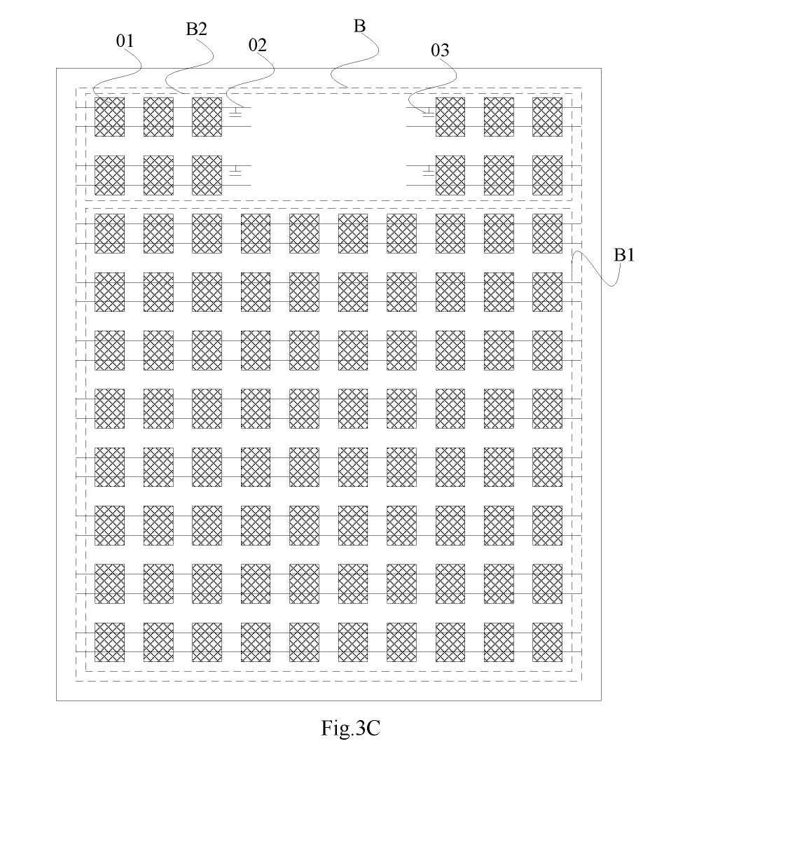

As illustrated in FIG. 3A and FIG. 3B, a display panel according to an embodiment of the disclosure includes a display area B including a plurality of rows of pixels 01, and scan signal lines 02 connected with the respective rows of pixels 01.

The display area B is divided into a first display area B1 and a second display area B2, and the number of pixels in a row of pixels 01 in the second display area B2 is smaller than the number of pixels in a row of pixels 01 in the first display area B1.

In the second display area B2, at least one of the respective scan signal lines 02 connected with the respective rows of pixels 01 is connected with a compensation capacitor 03.

In the above display panel according to the embodiment of the disclosure, when the display area B is divided into the first display area B1 and the second display area B2, and the number of pixels in a row of pixels 01 in the second display area B2 is smaller than the number of pixels in a row of pixels 01 in the first display area B1, a load on the scan signal line 02 connected with a row of pixels 01 in the second display area B2 is lower than a load on the scan signal line 02 connected with a row of pixels 01 in the first display area B 1. Further, at least one of the respective scan signal lines 02 connected with the respective rows of pixels 01 in the second display area B2 is connected with the compensation capacitor 03, so that the load on the scan signal line 02 connected with the compensation capacitor 03 can be increased to thereby reduce the difference in load between the scan signal line 02 in the second display area B2, and the scan signal line 02 in the first display area B1 so as to alleviate the problem of non-uniformly data writing due to the different loads on the scan signal lines 02, and further the non-uniformity of a displayed image.

In one embodiment, in the display panel above according to the embodiment of the disclosure, as illustrated in FIG. 3B, the respective scan signal lines 02 connected with the respective rows of pixels 01 in the second display area B2 can all be connected with compensation capacitors 03.

In the display panel above according to the embodiment of the disclosure, as needed in a real design, each row of pixels 01 can be connected concurrently with a plurality of scan signal lines 02 on which different signals are applied, or can be connected with only one scan signal line 02. When each row of pixels 01 is connected with a plurality of scan signal lines 02, all the scan signal lines 02 connected with the row of pixels 01 in the second display area B2 are connected with their corresponding compensation capacitors 03 to thereby reduce as many as possible the difference in load between the scan signal lines 02 in the second display area B2, and the respective scan signal lines 02 in the first display area B1 so as to alleviate as much as possible alleviate the problem of non-uniformly data writing due to the different loads on the respective scan signal lines 02, and further the non-uniformity of a displayed image.

In one embodiment, in the display panel above according to the embodiment of the disclosure, when each row of pixels 01 is connected with a plurality of scan signal lines 02, there are different loads on the respective scan signal lines 02, and also a varying influence upon non-uniformity of data writing. In view of this, as illustrated in FIG. 3A, alternatively only the scan signal line(s) 02 in the second display area B2 with a significant influence upon non-uniformity of data writing may be connected with a compensation capacitor 03, while the other scan signal lines 02 are arranged as in the first display area B1, so that non-uniformity of a displayed image can be alleviated, and also the difference in wiring between the first display area B1 and the second display area B2 can be reduced as many as possible to thereby facilitate uniformity of light transmitted through, and uniformity of an image displayed on, the display panel as a whole.

In one embodiment, in the display panel above according to the embodiment of the disclosure, as illustrated in FIG. 3A and FIG. 3B, a scan signal line 02 in the second display area B2 can be connected with a plurality of compensation capacitors 03, and the respective compensation capacitors 03 may correspond to respective ones of a plurality of pixels 01 connected to the scan signal line 02. Alternatively, in the display panel above according to the embodiment of the disclosure, as illustrated in FIG. 3C, a scan signal line 02 in the second display area B2 can be connected with one compensation capacitor 03, and the compensation capacitor 03 can be located in the display area B as illustrated in FIG. 3C, or in a non-display area, although the embodiment of the disclosure will not be limited thereto.

In one or more embodiment, each compensation capacitor 03 connected with the scan signal line 02 in the second display area B2 can be arranged in the area of the corresponding pixel 01, so that there may be the same wiring of the respective pixels 02 in the second display area B2, thus facilitating a design of a layout thereof. For example, each compensation capacitor 03 can be arranged in the pixel 01, or can be arranged at gaps between the pixels 01, although the embodiment of the disclosure will not be limited thereto.

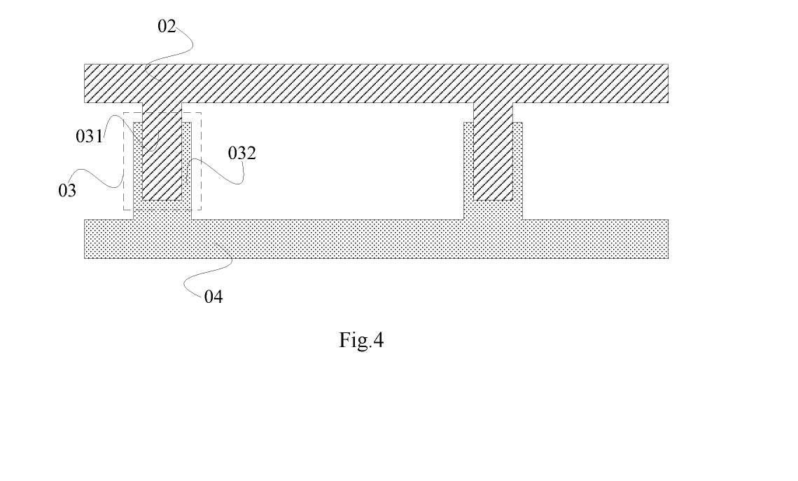

In one embodiment, in the display panel above according to the embodiment of the disclosure, as illustrated in FIG. 4, the compensation capacitor 03 can include a first terminal 031 and a second terminal 032. The first terminal 031 is structured integral to the scan signal line 02, and the second terminal 032 is connected with a fixed-potential signal line 04.

The first terminal 031 of the compensation capacitor 03 is arranged structurally integral to the scan signal line 02, that is, both of them are formed in the same patterning process, so that a fabrication process can be simplified and thus a fabrication cost can be saved. The second terminal 03 of the compensation capacitor 03 is connected with the fixed-potential signal line 04, so that an influence of the compensation capacitor 03 upon an electric signal applied to the scan signal line 02 can be alleviated as much as possible. Furthermore the second terminal 032 of the compensation capacitor 03 can also be arranged structurally integral to the fixed-potential signal line 04, that is, both of them are formed in the same patterning process. At this time, in order to form a capacitor structure of the compensation capacitor 03, the scan signal line 02 and the fixed-potential signal line 04 may be arranged at different layers, that is, they are located at the different layers with an insulation layer arranged there between as a medium of the compensation capacitor 03.

In one embodiment, in the display panel above according to the embodiment of the disclosure, the fixed-potential signal line 04 can be a power source voltage signal line PVDD, a reference signal line VREF, or a common voltage signal line VCOM.

Since all the power source voltage signal line PVDD, the reference signal line VREF, and the common voltage signal line VCOM are fixed-potential signal lines 04 existing in the display panel, there may be no additional wiring in the display panel, but the positional relationship between the layers may be altered as appropriate if needed, thus simplifying wiring in the display panel.

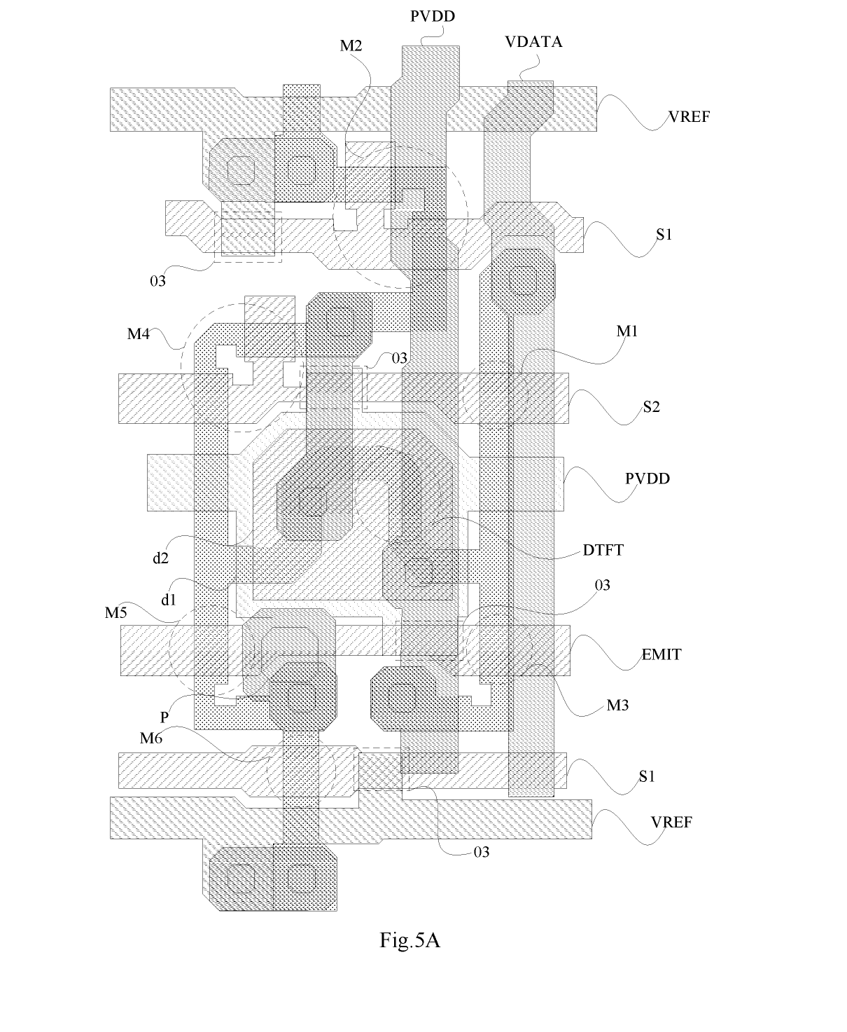

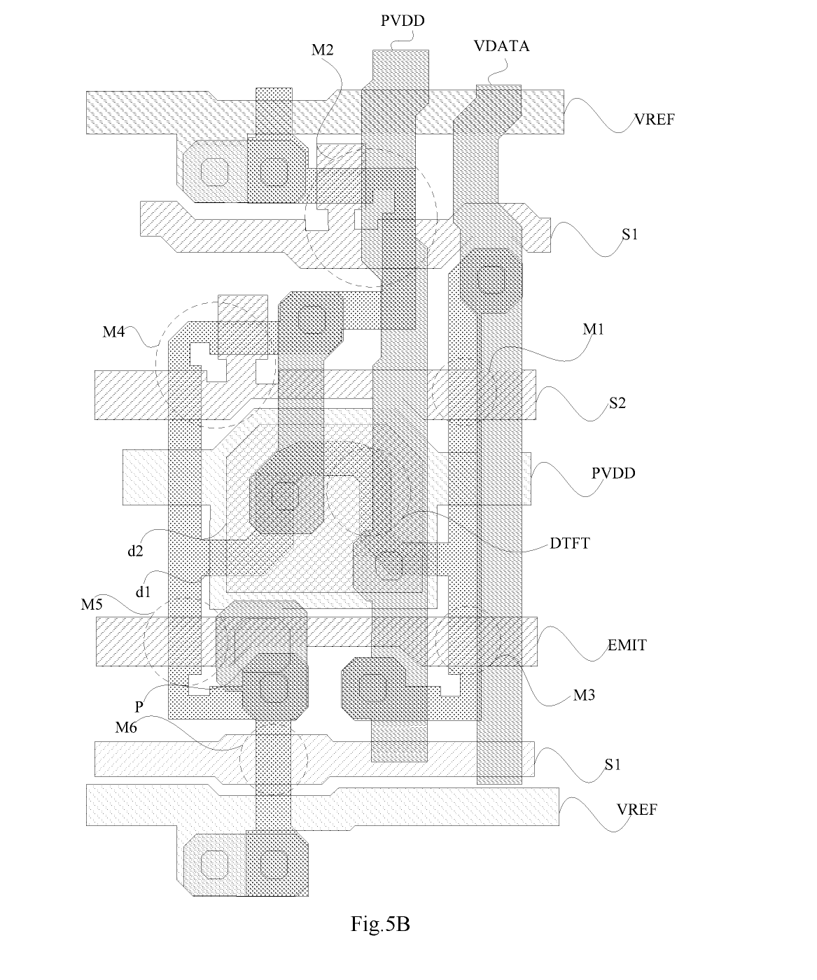

In one embodiment, when the display panel above according to the embodiment of the disclosure is applied to an OLED display panel, as illustrated in FIG. 5A and FIG. 5B, the scan signal line 02 generally includes a first scan signal line S1, a second scan signal line S2, and a light-emission control scan line EMIT.

In one embodiment, in the display panel above according to the embodiment of the disclosure, as illustrated in FIG. 5A, in the second display area B2, the first scan signal line S1 can be arranged at a different layer from the adjacent reference signal line VREF, and the compensation capacitors 03 can be formed in their overlapping areas.

In one more embodiment, section protruding to the adjacent first scan signal line S1 can be added to the reference signal line VREF, and the compensation capacitor 03 can be formed in the overlapping area between the adjacent first scan signal line S1 and the reference signal line VREF; alternatively, section protruding to the adjacent reference signal line VREF can be added to the first scan signal line S1, and the compensation capacitor 03 can be formed in the overlapping area between the adjacent reference signal line VREF and the first scan signal line S1. As can be apparent from comparison with the layout design in the first display area B1 illustrated in FIG. 5B, the overlapping areas between the reference signal lines VREF and the first scan signal lines S1 are added to the pixel layout in the second display area B2 without affecting the original design of the pixel layout.

In one embodiment, in the display panel above according to the embodiment of the disclosure, as illustrated in FIG. 5A, in the second display area B2, the second scan signal line S2 can be arranged at a different layer from the adjacent power source voltage signal line PVDD, and the compensation capacitor 03 can be formed in their overlapping area.

In one or more embodiment, section protruding to the adjacent second scan signal line S2 can be added to the power source voltage signal line PVDD, and the compensation capacitor 03 can be formed in the overlapping area between the adjacent second scan signal line S2 and the power source voltage signal line PVDD; alternatively, section protruding to the adjacent power source voltage signal line PVDD can be added to the second scan signal line S2, and the compensation capacitor 03 can be formed in the overlapping area between the adjacent power source voltage signal line PVDD and the second scan signal line S2. As can be apparent from comparison with the layout design in the first display area B1 illustrated in FIG. 5B, the overlapping areas between the power source voltage signal lines PVDD and the second scan signal lines S2 are added to the pixel layout in the second display area B2 without affecting the original design of the pixel layout.

In one embodiment, in the display panel above according to the embodiment of the disclosure, as illustrated in FIG. 5A, in the second display area B2, the light-emission control scan line EMIT can be arranged at a different layer from the adjacent power source voltage signal lines PVDD, and the compensation capacitors 03 can be formed in their overlapping area.

In one or more embodiment, section protruding to the adjacent light-emission control scan line EMIT can be added to the power source voltage signal line PVDD, and the compensation capacitor 03 can be formed in the overlapping area between the adjacent light-emission control scan line EMIT and the power source voltage signal line PVDD; alternatively, section protruding to the adjacent power source voltage signal line PVDD can be added to the light-emission control scan line EMIT, and the compensation capacitor 03 can be formed in the overlapping area between the adjacent power source voltage signal line PVDD and the light-emission control scan line EMIT. As can be apparent from comparison with the layout design in the first display area B1 illustrated in FIG. 5B, the overlapping areas between the power source voltage signal lines PVDD and the light-emission control scan lines EMIT are added to the pixel layout in the second display area B2 without affecting the original design of the pixel layout.

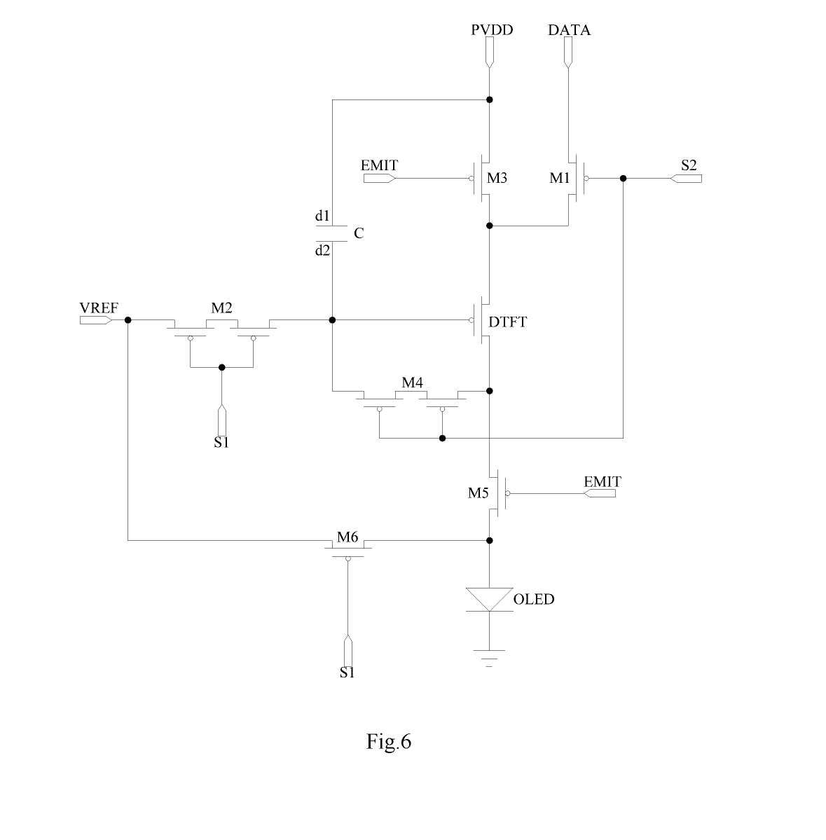

In one embodiment, in the display panel above according to the embodiment of the disclosure, as illustrated in FIG. 6, each pixel 01 can include at least a first switch transistor M1, an initialization transistor M2, a second switch transistor M3, a driving transistor DTFT, and an organic light-emitting diode OLED.

The initialization transistor M2 has a gate connected with one of the first scan signal lines S1; the first switch transistor M1 has a gate connected with one of the second scan signal lines S2; the second switch transistor M3 has a gate connected with one of the light-emission control scan lines EMIT; the driving transistor DTFT has a gate connected with a drain of the initialization transistor M2; the driving transistor DTFT has a source connected respectively with a drain of the first switch transistor M1, and a drain of the second switch transistor M3; and the OLED is connected with a drain of the driving transistor DTFT.

In one or more embodiment, the initialization transistor M2 has a source connected with one of the reference signal lines VREF, so that when the initialization transistor M2 is controlled by a signal of the first scan signal line S1 to be switched on, the gate of the driving transistor DTFT can be initialized by a reference potential on the reference signal line VREF. The first switch transistor M1 has a source connected with a data signal line VDATA, so that when the first switch transistor M1 is controlled by a signal of the second scan signal line S2 to be switched on, a data signal on the data signal line VDATA can be written into the source of the driving transistor DTFT. The second switch transistor M3 has a source connected with one of the power source voltage signal lines PVDD, so that when the second switch transistor M3 is controlled by a signal of the light-emission control line EMIT to be switched on, a power source signal provided on the power source voltage signal line PVDD can be written into the source of the driving transistor DTFT.

In one embodiment, the initialization transistor M2 can be arranged in a double-gate structure, so that leakage current in the initialization transistor M2 which is switched off can be reduced to thereby lower interference to the driving transistor DTFT from leakage current in the initialization transistor M2 in a light-emission stage, which would otherwise influence driving current of the driving transistor DTFT.

The particular scheme structure of the pixel 01 illustrated in FIG. 6 above has been described only by way of an example, but another connection pattern can alternatively be applicable to the particular scheme structure of the pixel 01, although the embodiment of the disclosure will not be limited thereto.

In one embodiment, in the display panel above according to the embodiment of the disclosure, as illustrated in FIG. 6, the pixel 01 generally can further include a storage capacitor C. The storage capacitor C has a first terminal d1 connected with the power source voltage signal line PVDD, and a second terminal d2 connected with the gate of the driving transistor DTFT. Unlike the compensation capacitor 03, the storage capacitor C is configured to store voltage at the gate of the driving transistor DTFT.

In one embodiment, in the display panel above according to the embodiment of the disclosure, as illustrated in FIG. 6, the pixel 01 generally can further include a compensation transistor M4. The compensation transistor M4 has a gate connected with the second scan signal line S2, a source connected with the gate of the driving transistor DTFT, and a drain connected with the drain of the driving transistor DTFT.

In one or more embodiment, when the compensation transistor M4 is controlled by a signal of the second scan signal line S2 to be switched on, the compensation transistor M4 communicates the drain of the driving transistor DTFT with the gate thereof. That is, when the first switch transistor M1 is switched on by a signal of the second scan signal line S2, the compensation transistor M4 is also switched on, and the data signal from the data signal line VDATA is applied to the source of the driving transistor DTFT through the first switch transistor M1 which is switched on, and the voltage between the source and the gate of the driving transistor DTFT is Vdata-|Vth|, that is, the voltage at the gate of the driving transistor DTFT is compensated for in the data writing stage by threshold voltage of the driving transistor DTFT, so that an influence of |Vth| in the driving current to be input from the driving transistor DTFT to the OLED in the light-emission stage, i.e., an influence of the drifting of threshold voltage of the driving transistor upon light-emission, can be eliminated, thus enabling a threshold voltage compensation function in the organic electroluminescent display panel.

In one embodiment, the compensation transistor M4 can be arranged in a double-gate structure, so that leakage current in the compensation transistor M4 which is switched off can be reduced to thereby lower interference to the driving transistor DTFT from leakage current in the compensation transistor M4 in the light-emission stage, which would otherwise influence driving current of the driving transistor DTFT.

In one embodiment, in the display panel above according to the embodiment of the disclosure, as illustrated in FIG. 6, the pixel 01 generally can further include a light-emission control transistor M5. The light-emission control transistor M5 has a gate connected with the light-emission control line EMIT, a source connected with the drain of the driving transistor DTFT, and a drain connected with the OLED.

In one or more embodiment, when the light-emission control transistor M5 is controlled by a signal of the light-emission control line EMIT to be switched on, the light-emission control transistor M5 communicates the drain of the driving transistor DTFT with the organic light-emitting diode OLED. The light-emission control transistor M5 is switched off in both the initialization stage and the data writing stage, so that the organic light-emitting diode OLED can be avoided from being driven by driving current to emit light in these two stages.

In one embodiment, in the display panel above according to the embodiment of the disclosure, as illustrated in FIG. 6, the pixel 01 generally further include an anode reset transistor M6. The anode reset transistor M6 has a gate connected with the first scan signal line S1, a source connected with the reference signal line VREF, and a drain connected with the organic light-emitting diode OLED.

In one or more embodiment, when the anode reset transistor M6 is controlled by a signal of the first scan signal line Si to be switched on, the anode reset transistor M6 communicates the OLED with the reference signal line VREF. When the initialization transistor M2 is switched on by a signal of the first scan signal line S1, the anode reset transistor M6 is also switched on, and the gate of the driving transistor DTFT and the OLED are initialized and reset by the reference signal line VREF through the initialization transistor M2 and the anode reset transistor M6 respectively.

In one embodiment, in the display panel above according to the embodiment of the disclosure, as illustrated in FIG. 5A and FIG. 5B, there are no overlapping areas between the first scan signal lines S1, the second scan signal lines S2, the light-emission control lines EMIT, and the second terminals d2 of the storage capacitors C, so they can be arranged at the same first metal layer. There are no connections between the traverse power source voltage signal lines PVDD, the first terminals d1 of the storage capacitors C, and the reference signal lines VREF, so they can be arranged at a second metal layer. The data signal lines DATA, and the longitudinal power source voltage signal lines PVDD are parallel to each other, so they can be arranged at a third metal layer. In order to accommodate the connections between the components at the respective metal layers, corresponding insulation layers may need to be arranged between the first metal layer, the second metal layer, and the third metal layer, and proper via-holes may formed set as needed. Channel areas of the respective transistors are arranged at a semiconductor layer, a corresponding doping process is performed on the sources and the drains. The semiconductor layer is typically low-temperature poly-Si, and is typically arranged below the first metal layer as needed for a process. It shall be noted that the components at the respective layers in FIG. 5A and FIG. 5B are filled with the same pattern, and the different films are filled with different patterns to be distinguished from each other.

It shall be noted that the organic light-emitting diodes OLED are not illustrated in the schematic structural diagrams illustrated in FIG. 5A and FIG. 5B, but sections P connected with their anodes are illustrated.

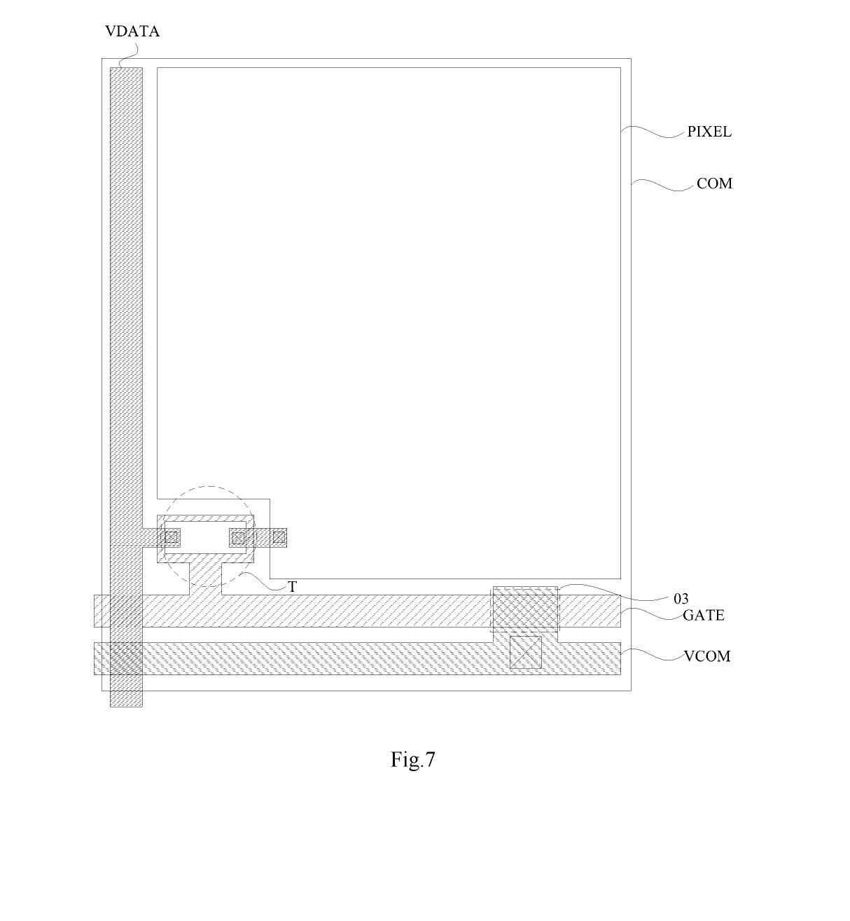

In one embodiment, when the display panel above according to the embodiment of the disclosure is applied to a liquid crystal display (LCD), as illustrated in FIG. 7, the scan signal lines 02 are gate signal lines GATE.

In one embodiment, in the display panel above according to the embodiment of the disclosure, as illustrated in FIG. 7, in the second display area B2, the gate signal lines GATE can be arranged at a different layer from the adjacent common voltage signal lines VCOM, and the compensation capacitors 03 can be formed in the overlapping areas there between.

In one or more embodiment, section protruding to the adjacent gate signal line GATE can be added to the common voltage signal line VCOM, and the compensation capacitors 03 can be formed in the overlapping area between the adjacent gate signal lines GATE and the common voltage signal line VCOM. The overlapping areas between the common voltage signal lines VCOM and the gate signal lines GATE are added to the pixel layout in the second display area B2 without affecting the original design of the pixel layout.

In one embodiment, in the display panel above according to the embodiment of the disclosure, as illustrated in FIG. 7, the pixel 01 can include at least a pixel switch T, a pixel electrode PIXEL, and a common electrode COM.

The pixel switch T has a gate connected with one of the gate signal line GATE, and a drain connected with the pixel electrode PIXEL. The common electrode COM is connected with one of the common voltage signal lines VCOM.

In one or more embodiment, a source of the pixel switch T is typically connected with one of the data signal lines VDATA, so that when the pixel switch T is controlled by a signal of the gate signal line GATE to be switched on, the data signal on the data signal line VDATA is written into the pixel electrode PIXEL. In one embodiment, the pixel switch T can be arranged in a double-gate structure, so that leakage current in the pixel switch T which is switched off can be reduced.

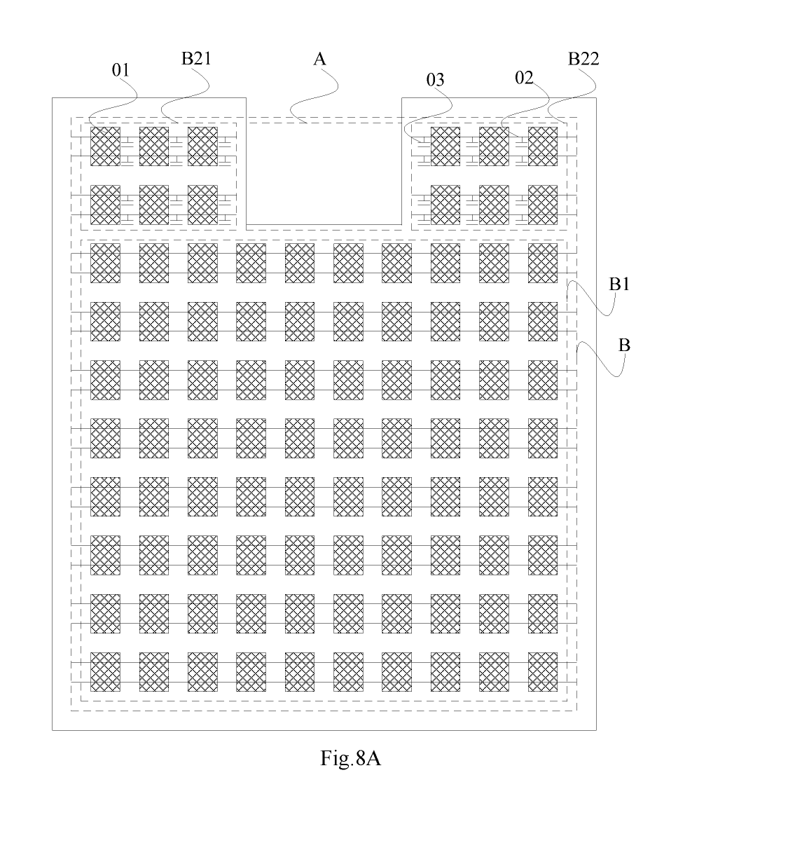

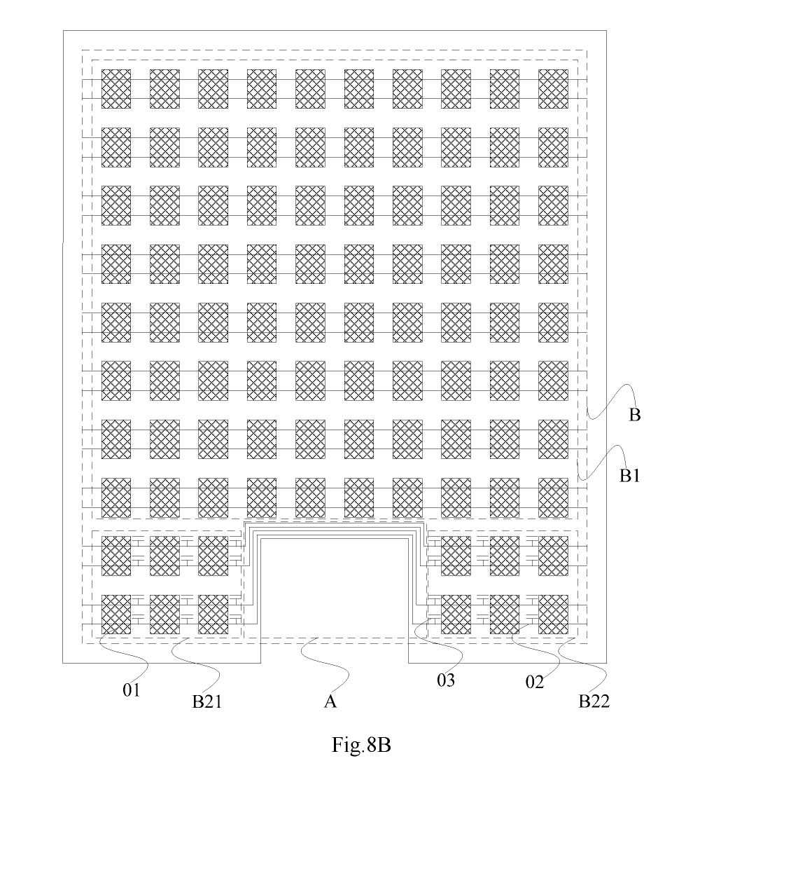

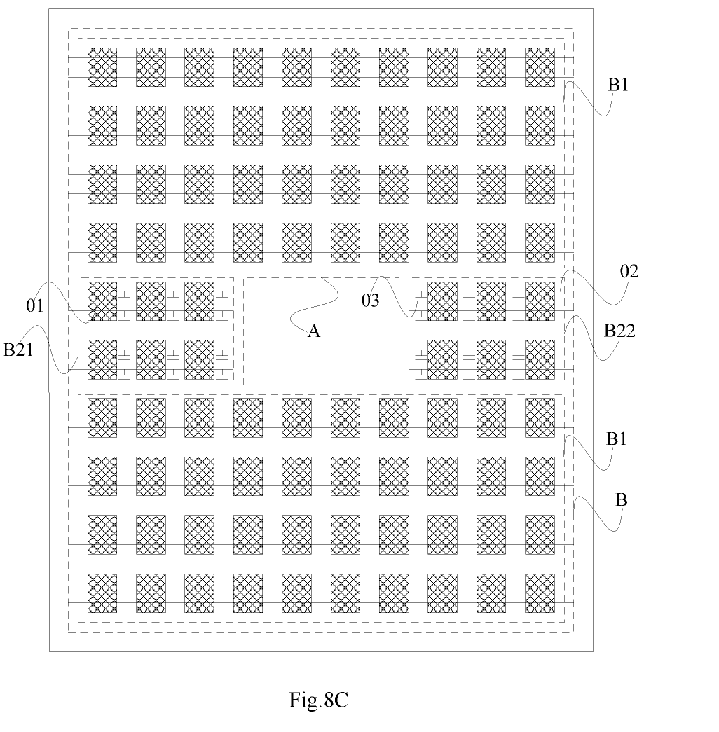

In one embodiment, in the display panel above according to the embodiment of the disclosure, as illustrated in FIG. 8A and FIG. 8B, the second display area B2 can be located at the top or the bottom of the first display area B1, and the second display area B2 can be divided into a first sub-area B21 and a second sub-area B22, where a part of pixels 01 in each row of pixels 01 in the second display area B2 are located in the first sub-area B21, and the remaining part of the pixels 01 are located in the second sub-area B22. The display panel further includes a notch-shaped area A, and the first sub-area B21 is spaced from the second sub-area B22 by the notch-shaped area A.

In one or more embodiment, when the second display area B2 as illustrated in FIG. 8A is located at the top of the first display area B1, or the second display area B2 as illustrated in FIG. 8B is located at the bottom of the first display area B1, one or a combination of a camera, a headphone, a light ray sensor, a distance sensor, an iris recognition sensor, and a fingerprint recognition sensor can be arranged in the notch-shaped area A. In one embodiment, the second display area B2 can alternatively be located at the center of the first display area B1 as illustrated in FIG. 8C. It shall be noted that the particular position where the second display area B2 is arranged may be designed as needed for the product, although the embodiment of the disclosure will not be limited thereto.

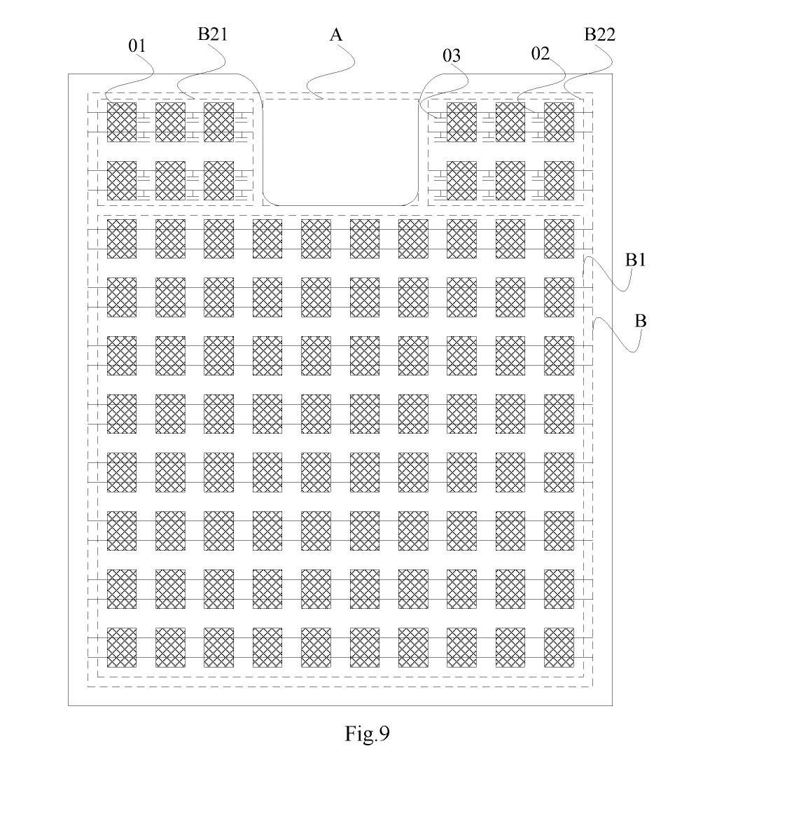

In one embodiment, in the display panel above according to the embodiment of the disclosure, as illustrated in FIG. 9, the outline of a part of a frame of the notch-shaped area A can be an arc.

In one or more embodiment, the outline of the frame of the notch-shaped area A can be preset according to a particular shape of an element to be arranged in the notch-shaped area A. For example, when the outline of an element to be arranged in the notch-shaped area A is an arc, e.g., a round camera, as illustrated in FIG. 9, the outline of a part of the frame of the notch-shaped area A can be an arc. In another example, when a plurality of elements may need to be arranged in the notch-shaped area A, as illustrated in FIG. 8A to FIG. 8C, the outline of the frame of the notch-shaped area A is typically a rectangle.

In one embodiment, in the display panel above according to the embodiment of the disclosure, as illustrated in FIG. 8C, the notch-shaped area A can be a transparent display area, and the overall outline of the display panel is a regular pattern. There are no pixels 01 to be arranged in the notch-shaped area A, so that the notch-shaped area A is an area through which light can be transmitted. Alternatively the notch-shaped area A can be cut away as illustrated in FIG. 8A and FIG. 8B as needed in reality, that is, the underlying substrate of the display panel is cut away in the notch-shaped area A, so that such elements as a camera, a headphone, a light ray sensor, a distance sensor, an iris recognition sensor, a fingerprint recognition sensor, etc. can be arranged, although the embodiment of the disclosure will not be limited thereto.

In one embodiment, in the display panel above according to the embodiment of the disclosure, as illustrated in FIG. 8A to FIG. 8C, the first sub-area B21 and the second sub-area B22 can be arranged in a symmetric pattern, that is, the notch-shaped area A is arranged at the center of the second display area B2, thus improving a visually pleasant effect of the display panel.

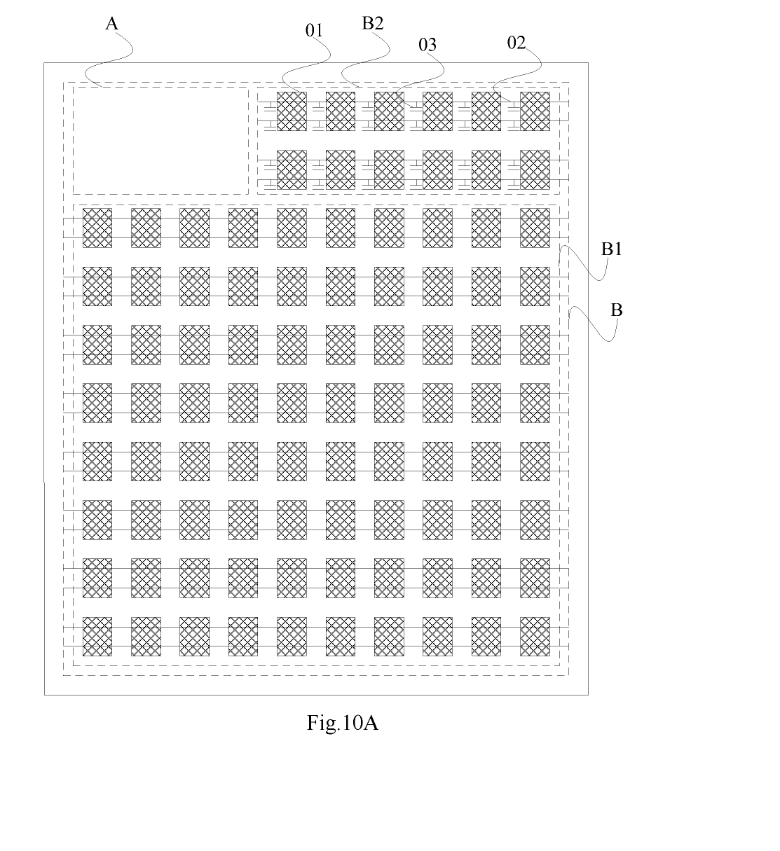

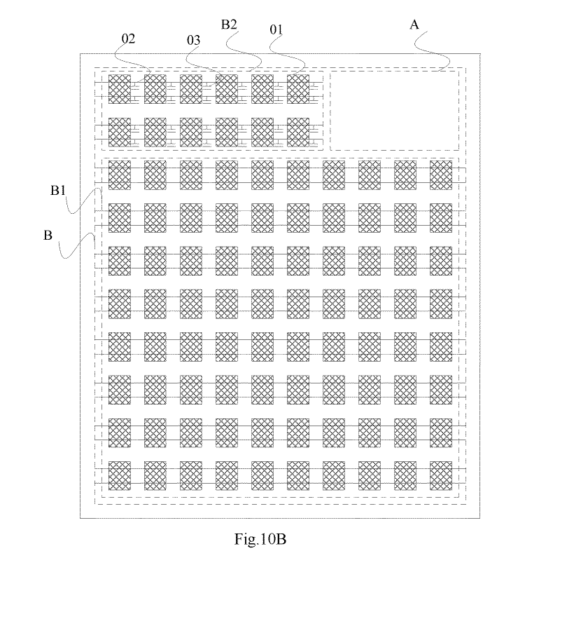

Alternatively in the display panel above according to the embodiment of the disclosure, the notch-shaped area A can be located on the left of the second display area B2 as illustrated in FIG. 10A; or the notch-shaped area A can be located on the right of the second display area B2 as illustrated in FIG. 10B, although the embodiment of the disclosure will not be limited thereto.

In one embodiment, in the display panel above according to the embodiment of the disclosure, as illustrated in FIG. 8A, the scan signal lines 02 in the first sub-area B21, and the scan signal lines 02 in the second sub-area B22 can be disconnected from each other in the notch-shaped area A.

Since the scan signal lines 02 in the first sub-area B21, and the scan signal lines 02 in the second sub-area B22 can be disconnected from each other in the notch-shaped area A, the width of the frame of the notch-shaped area A and be reduced so as to facilitate a design of the narrow edge frame.

In one embodiment, in the display panel above according to the embodiment of the disclosure, as illustrated in FIG. 8B, the scan signal lines 02 in the first sub-area B21, and the scan signal lines 02 in the second sub-area B22 can be connected with each other in the notch-shaped area A.

Since the scan signal lines 02 in the first sub-area B21, and the scan signal lines 02 in the second sub-area B22 can alternatively be connected with each other in the notch-shaped area

A, the difference in load between the scan signal lines 02 in the second display area B2 and those in the first display area B1 can be reduced. Furthermore the scan signal lines 02 in the second display area B2 and the first display area B1 both can be driven bilaterally.

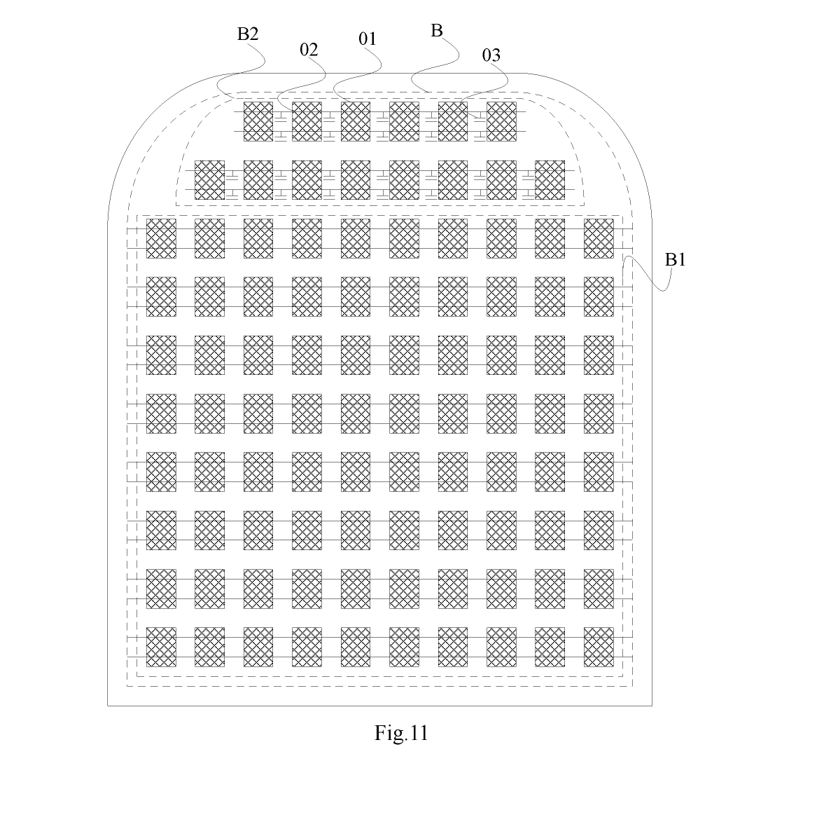

In one embodiment, the display panel according to the embodiment of the disclosure can also be applicable to a product including the display area B with rounded corners, that is, there may be no notch-shaped area A in the display panel. As illustrated in FIG. 11, for example, there are rounded corners at edges of the second display area B2 proximate to display panel, so that the number of pixels in a row of pixels 01 in the second display area B2 is smaller than the number of pixels in a row of pixels 01 in the first display area B1.

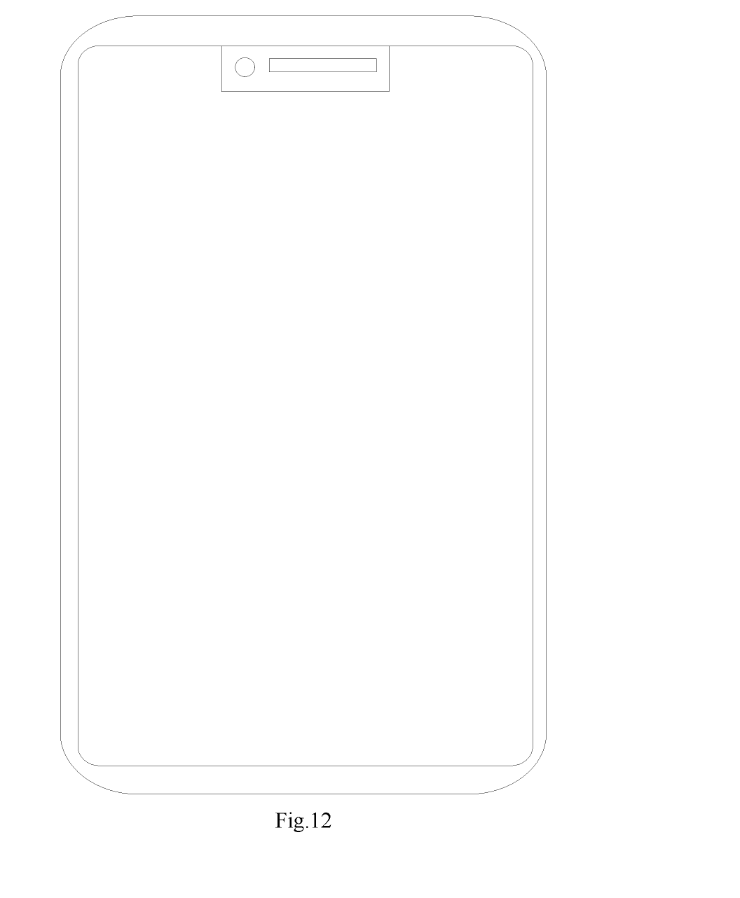

Based upon the same inventive idea, an embodiment of the disclosure further provides a display device as illustrated in FIG. 12 including the display panel above according to any one of the embodiments of the disclosure. The display device can be a mobile phone, a tablet computer, a TV set, a monitor, a notebook computer, a digital photo frame, a navigator, or any other product or component with a display function. Reference can be made to the embodiments of the display panel above for an implementation of the display device, so a repeated description thereof will be omitted here.

In the display panel and the display device according to the embodiments of the disclosure, when the display area is divided into the first display area and the second display area, and the number of pixels in a row of pixels in the second display area is smaller than the number of pixels in a row of pixels in the first display area, a load on the scan signal line connected with a row of pixels in the second display area is lower than a load on the scan signal line connected with a row of pixels in the first display area, and at least one of the respective scan signal lines connected with the respective rows of pixels in the second display area is connected with the compensation capacitor, so that the load on the scan signal line connected with the compensation capacitor can be increased to thereby reduce the difference in load between the scan signal line in the second display area, and the scan signal line in the first display area so as to alleviate the problem of non-uniformly data writing due to the different loads on the scan signal lines, and further the non-uniformity of a displayed image.

1. A display panel, comprising:
a display area comprising a plurality of rows of pixels, and scan signal lines connected with the respective rows of pixels, wherein:
the display area is divided into a first display area and a second display area, and a number of pixels in a row of pixels in the second display area is smaller than a number of pixels in a row of pixels in the first display area; and
in the second display area, at least one of the respective scan signal lines connected with the respective rows of pixels is connected with a compensation capacitor.

2. The display panel according to claim 1, wherein each of the respective scan signal lines connected with the respective rows of pixels in the second display area is connected with a compensation capacitor.

3. The display panel according to claim 1, wherein each of the scan signal lines in the second display area is connected with a plurality of compensation capacitors, and the respective compensation capacitors correspond to the respective pixels connected to the scan signal line.

4. The display panel according to claim 1, wherein the compensation capacitor comprises a first terminal and a second terminal, the first terminal being structured integral to the scan signal line, and the second terminal being connected with a fixed-potential signal line.

5. The display panel according to claim 4, wherein the fixed-potential signal line is one of: a power source voltage signal line, a reference signal line, and a common voltage signal line.

6. The display panel according to claim 5, wherein the scan signal line comprise first scan signal line, a second scan signal line, and a light-emission control scan line.

7. The display panel according to claim 6, wherein in the second display area, the first scan signal line is arranged at a different layer from adjacent reference signal line, and the compensation capacitors is formed in overlapping area there between.

8. The display panel according to claim 6, wherein in the second display area, the second scan signal line is arranged at a different layer from adjacent power source voltage signal line, and the compensation capacitors is formed in overlapping area there between.

9. The display panel according to claim 6, wherein in the second display area, the light-emission control scan line is arranged at a different layer from adjacent power source voltage signal line, and the compensation capacitors is formed in overlapping area there between.

10. The display panel according to claim 6, wherein each pixel comprises:
at least a first switch transistor, an initialization transistor, a second switch transistor, a driving transistor, and an organic light-emitting diode; and
the initialization transistor comprises: a gate connected with the first scan signal line;
the first switch transistor has a gate connected with the second scan signal line;
the second switch transistor has a gate connected with the light-emission control scan line;
the driving transistor has a gate connected with a drain of the initialization transistor, and a source connected respectively with a drain of the first switch transistor, and a drain of the second switch transistor; and
the organic light-emitting diode is connected with a drain of the driving transistor.

11. The display panel according to claim 10, wherein the pixel further comprises a storage capacitor with a first terminal d1 connected with the power source voltage signal line, and a second terminal connected with the gate of the driving transistor, and the storage capacitor is configured to store voltage at the gate of the driving transistor.

12. The display panel according to claim 5, wherein the scan signal line is a gate signal line.

13. The display panel according to claim 12, wherein in the second display area, the gate signal line is arranged at a different layer from adjacent common voltage signal line, and the compensation capacitors is formed in overlapping area there between.

14. The display panel according to claim 13, wherein the pixel comprises at least a pixel switch, a pixel electrode, and a common electrode; and
the pixel switch has a gate connected with the gate signal line, and a drain connected with the pixel electrode; and the common electrode is connected with the common voltage signal line.

15. The display panel according to claim 1, wherein the second display area is located at top or bottom of the first display area, and the second display area is divided into a first sub-area and a second sub-area; and a part of pixels in each row of pixels in the second display area are located in the first sub-area, and a remaining part of the pixels are located in the second sub-area; and
the display panel further comprises a notch-shaped area by which the first sub-area is spaced from the second sub-area.

16. The display panel according to claim 15, wherein outline of a part of an edge of the notch-shaped area is an arc.

17. The display panel according to claim 15, wherein the notch-shaped area is a transparent display area.

18. The display panel according to claim 15, wherein the first sub-area and the second sub-area are arranged in a symmetric pattern.

19. The display panel according to claim 15, wherein scan signal lines in the first sub-area, and scan signal lines in the second sub-area are disconnected from each other in the notch-shaped area.

20. The display panel according to claim 15, wherein scan signal lines in the first sub-area, and scan signal lines in the second sub-area are connected with each other in the notch-shaped area.

21. A display device, comprising:
a display panel, comprising:
a display area comprising a plurality of rows of pixels, and scan signal lines connected with the respective rows of pixels, wherein:
the display area is divided into a first display area and a second display area, and a number of pixels in a row of pixels in the second display area is smaller than a number of pixels in a row of pixels in the first display area; and
in the second display area, at least one of the respective scan signal lines connected with the respective rows of pixels is connected with a compensation capacitor.
